(19) United States
(12) Patent Application Publication
(10) Pub. No.: US 2004/0107816 A1
(43) Pub. Date: Jun. 10, 2004

(54) Housing for band sawing machine

(75) Inventor: Lien-Chu Lee, Taichung Hsien (TW)

Correspondence Address: BROWDY AND NEIMARK, P.L.L.C., 624 NINTH STREET, NW, SUITE 300, WASHINGTON, DC, 20001-5303, US

(73) Assignee: OAV Equipment & Tools, Inc., Taichung Hsien (TW)

(21) Appl. No.: 10/354,984

(22) Filed: Jan. 31, 2003

(30) Foreign Application Priority Data
Dec. 4, 2002 (TW) 91219629

(51) Int. Cl. B27B 13/00

(52) U.S. Cl. 83/788

(57) ABSTRACT

A housing of a band sawing machine is composed of a bottom shell and at least one cover shell. The bottom shell and the cover shell are respectively made of a metal sheet by stamping. The bottom shell has a peripheral wall perpendicularly extending from a border thereof. The cover shell has a lateral side hinged to a lateral side of the peripheral wall of the bottom shell such that the cover shell can be turned to close/open the housing. According to an alternate design of the present invention, the housing is composed of a bottom shell and two cover shells respectively hinged to the lateral side of the peripheral wall of the bottom shell at different elevations.

### BACKGROUND OF THE INVENTION

1. Field of the Invention

The present invention relates generally to band sawing machines, and more specifically to a housing for a band sawing machine.

2. Description of the Related Art

A housing of a regular band sawing machine has a substantially C-shaped profile, an open space positioned at the middle thereof adapted to accommodate a worktable, and an inside space adapted to accommodate a drive wheel and a driven wheel. Further, the housing of the conventional band sawing machine is composed of a bottom shell and a cover shell. The drive wheel, the driven wheel, and other component parts of the band sawing machine are mounted in the bottom shell. The cover shell is adapted to cover the bottom shell. During a repair or maintenance work, the cover shell can be detachably removed from the bottom shell.

According to the design of the prior art, the cover shell and the bottom shell are respectively formed of multiple shell parts (fastened together by welding or rivets or screws). The bottom shell has a C-shaped main body and a winding-sheet-shaped peripheral wall. The main body is formed of two shell parts. The peripheral wall may be separately made, and then fastened around a border of the main body. The housing of this design for the band sawing machine is complicated, thereby resulting in high manufacturing cost.

### SUMMARY OF THE INVENTION

The present invention has been accomplished under the circumstances in view. It is therefore the main object of the present invention to provide a housing for a band sawing machine, wherein the housing is manufactured easily and inexpensively.

To achieve the foregoing objects of the present invention, the housing of the band sawing machine is composed of a bottom shell and at least one cover shell. The bottom shell and the cover shell are respectively made of a metal sheet by stamping. The bottom shell has a peripheral wall perpendicularly extending from a border thereof. The cover shell has a lateral side hinged to a lateral side of the peripheral wall of the bottom shell such that the cover shell can be turned to close/open the housing. According to an alternate design of the present invention, the housing is composed of a bottom shell and two cover shells respectively hinged to the lateral side of the peripheral wall of the bottom shell at different elevations.

### BRIEF DESCRIPTION OF THE DRAWINGS

FIG. 1 is an exploded view of a first preferred embodiment of the present invention.

FIG. 2 is a perspective view the first preferred embodiment of the present invention.

FIG. 3 is an exploded view of a second preferred embodiment of the present invention.

### DETAILED DESCRIPTION OF THE INVENTION

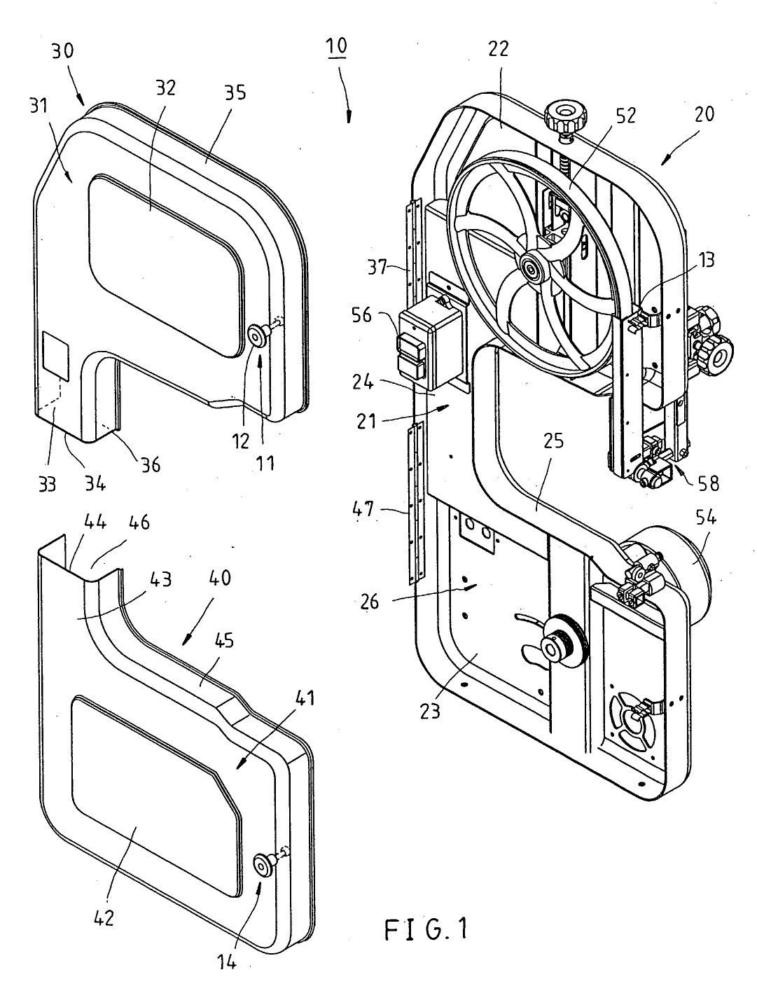

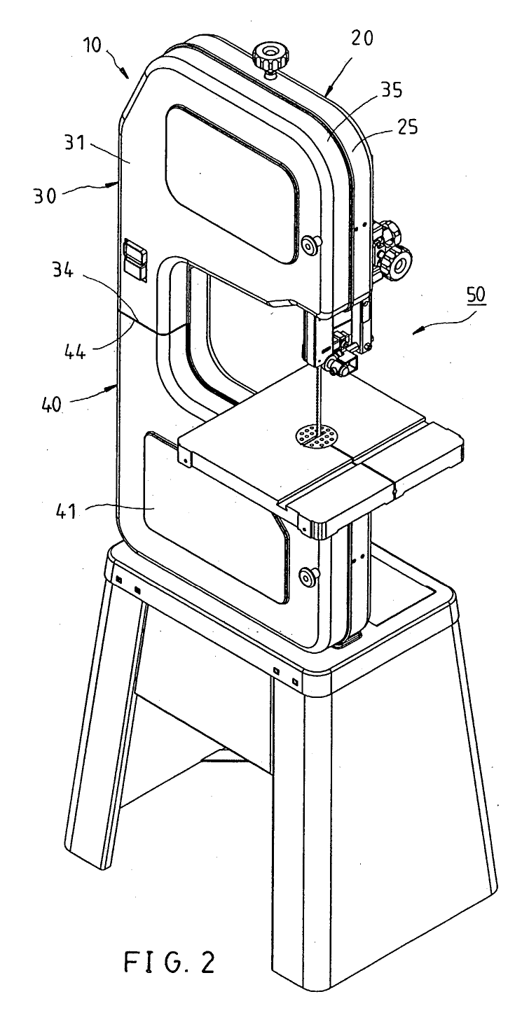

Referring to FIGS. 1 and 2, a housing 10 in accordance with the first preferred embodiment of the present invention is composed of a bottom shell 20, an upper cover shell 30, and a lower cover shell 40.

The bottom shell 20 includes an upright base panel 21, which is formed of an upper part 22, a lower part 23 spaced below the upper part 22 at a distance, a connecting part 24 vertically connected between the upper part 22 and the lower part 23 at a lateral side (the left side as shown in FIG. 1), and a peripheral wall 25 perpendicularly inwardly extending along a border of the base panel 21. The upper part 22 of the base panel 21 has two top corners respectively beveled (the upper left corner) and chamfered (the upper right corner). The peripheral wall 25 and the base panel 21 define a receiving space 26 adapted to accommodate a drive wheel (not shown) and a driven wheel 52. It is to be noted that the aforesaid drive wheel and driven wheel and the other parts of the band sawing machine, such as band saw, worktable, motor 54, switch 56, a band saw lock 58, and so on, are not within the scope of the invention, and therefore no further detailed description in this regard is necessary.

The upper cover shell 30 includes an upright base panel 31, which is formed of a main body 32, a bottom extension 33 extending downwardly from a bottom side of the main body 32 at a lateral side (the left side as shown in FIG. 1), and a peripheral wall 35 perpendicularly extending along a border of the base panel 31. The main body 32 of the base panel 31 of the upper cover shell 30 fits the upper part 22 of the base panel 21 of the bottom shell 20. The bottom extension 33 defines a connecting side edge 34 at a bottom end thereof and the connecting side edge 34 has an opening 36. The upper cover shell 30 is covered on the upper part 22 of the bottom shell 20, keeping the peripheral wall 35 of the upper cover shell 30 approaching the peripheral wall 25 of the bottom shell 20 (see FIG. 2). According to this embodiment, the upper cover shell 30 is fastened pivotally with the peripheral wall 25 of the bottom shell 20 by a hinge 37 at a lateral side thereof, namely, a left side adjacent to the connecting part 24 in FIG. 1. Thus, the upper cover shell 30 can be turned relative to the bottom shell 20 to expose the inside of the bottom shell 20. A lock 11 is provided at the other side, namely, the right side in FIG. 1, and adapted to lock the upper cover shell 30 together with the upper part 22 of the bottom shell 20. The lock 11 is composed of a bolt 12 fastened pivotally with the main body 32 of the base panel 31 of the upper cover shell 30 at the right side, and a retainer 13 mounted on the bottom shell 20 adapted to receive the bolt 12. When the upper cover shell 30 is covered onto the upper part 22 of the bottom shell 20, the bolt 12 is forced into the retainer 13 and secured in place by the retainer 13. After the upper cover shell 30 is covered onto the upper part 22 of the bottom shell 20, the user can pull the bolt 12 and then open the upper cover shell 30.

The lower cover shell 40 includes a base panel 41, which is formed of a main body 42 and a top extension 43 upwardly extending from a top side of the main body 22 at a lateral side (the left side as shown in FIG. 1), and a peripheral wall 45 perpendicularly extending along a border of the base panel 41. The main body 42 of the base panel 41 of the upper cover shell 40 fits the lower part 23 of the base panel 21 of the bottom shell 20. The top extension 43 has a connecting side edge 44 a top end and the connecting side edge 44 defining an opening 46. The lower cover shell 40 is covered on the lower part 23 of the bottom shell 20, keeping the peripheral wall 45 of the lower cover shell 40 abutted against the peripheral wall 25 of the bottom shell 20 (see FIG. 2). According to this embodiment, the lower cover shell 40 is fastened pivotally with the peripheral wall 25 of the bottom shell 20 by a hinge 47 at a lateral side, namely, the left side adjacent to the connecting part 24 in FIG. 1. Thus, the lower cover shell 40 can be turned relative to the bottom shell 20 to expose the inside of the lower part 23 of the bottom shell 20. A lock 14 is provided at the other side, namely, the right side in FIG. 1, and adapted to lock the lower cover shell 40 together with the lower part 23 of the bottom shell 20. When the upper cover shell 30 and the lower cover shell 40 are covered onto the bottom shell 20, the connecting side edges 34 and 44 are abutted against each other, and the base panels 31 and 41 of the upper and lower cover shells 30 and 40 fit over the base panel 21 of the bottom shell 20.

FIG. 2 illustrates the housing 10 installed a band sawing machine 50. As indicated above, the upper cover shell 30 and the lower cover shell 40 are respectively hinged to the bottom shell 20. While examining or repairing machine parts in the upper part 22 of the bottom shell 20 (for example, the driven wheel 52) or in the lower part 23 of the bottom shell 20 (for example, driving mechanism), it's as easy as opening the upper cover shell 30 or the lower cover shell 40.

Further, the bottom shell 20, upper cover shell 30, and lower cover shell 40 of the housing 10 are respectively made of a metal sheet by stamping so as to have advantages of easy fabrication and low manufacturing cost.

In the aforesaid first embodiment, the upper cover shell 30 and the lower cover shell 40 are symmetrical, i.e., the base panel 31 of the upper cover shell 30 and the base panel 41 of the lower cover shell 40 are combined together to fit the shape of the base panel 21 of the bottom shell 20. Alternatively, the upper cover shell 30 and the lower cover shell 40 can be made in different shapes. For example, one of cover shell 30 and 40 can be made relatively bigger than the other one, and the bigger cover shell 30 or 40 covers over the connecting part 24 of the bottom shell 20. In any alternate form, the upper cover shell 30 and the lower cover shell 40 are combined together to fit the shape of the bottom shell 20.

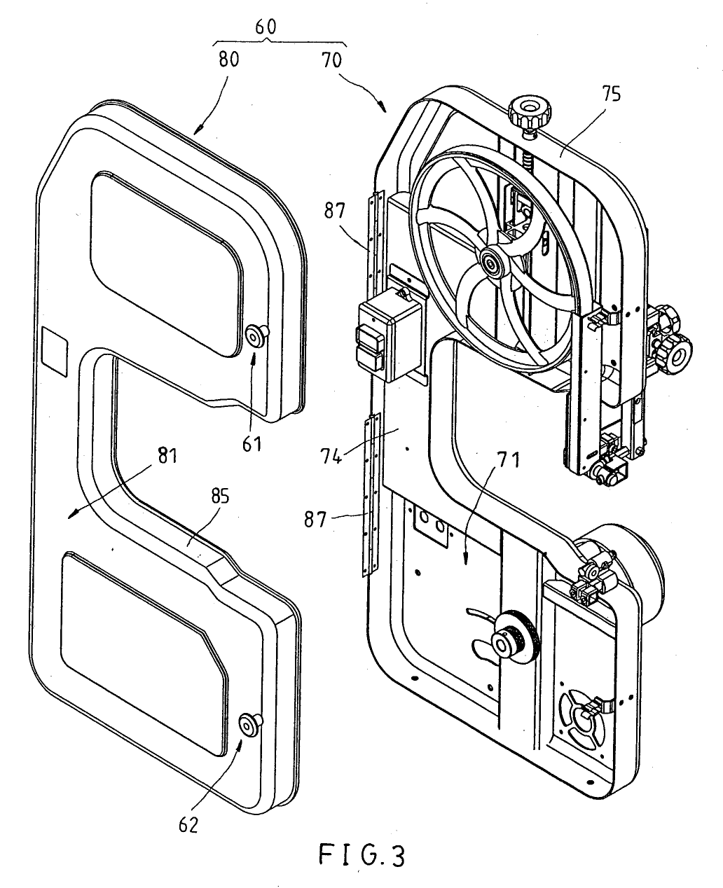

Referring to FIG. 3, according to a second preferred embodiment, the housing 60 is composed of a bottom shell 70 and a cover shell 80 covering the bottom shell 70. The bottom shell 70 and the cover shell 80 are respectively made of a metal sheet by stamping. The shape of the bottom shell 70 is the same as the bottom shell 20 of the first embodiment shown in FIGS. 1 and 2. The cover shell 80 includes a base panel 81 fitting the base panel 71 of the bottom shell 70, and a peripheral wall 85 perpendicularly extending along the border of the base panel 81. Two hinges 87 are connected between the peripheral wall 75 of the bottom shell 70 and the peripheral wall 85 of the cover shell 80 at a side corresponding to the middle connecting part 74 of the bottom shell 70, for enabling the cover shell 80 to be turned relative to the bottom shell 70 to close/open the bottom shell 70. Two locks 61 and 62 are provided at the other side for locking the cover shell 80 together with the bottom shell 70.

Because the bottom shell 70 and the cover shell 80 are respectively made of a metal sheet by stamping, the manufacturing cost of the housing 60 is low.

Moreover, the cover shells including the upper cover shell 30 and a lower cover shell 40 in the first embodiment and the cover shell 80 in the second embodiment can be alternatively not provided with peripheral walls 35, 45, 85. In other words, while the cover shell covers the bottom shell, the receiving space can still be covered by the border of the cover shell fitting against the border of the base panel.

What is claimed is:

1. A housing for a band sawing machine comprising:
a bottom shell made of a metal sheet by stamping and including a base panel and a peripheral wall perpendicularly extending from a border of said base panel of said bottom shell, said base panel of said bottom shell having an upper part, a lower part, and a connecting part connected between said upper part and said lower part at a side thereof;
an upper cover shell made of a metal sheet by stamping and adapted to cover said upper part of said base panel of said bottom shell, said upper cover shell comprising a base panel adapted to cover said upper part of said base panel of said bottom shell, said base panel of said upper cover shell having a connecting side edge disposed at a bottom side thereof corresponding to said connecting part of said base panel of said bottom shell, and
a lower cover shell made of a metal sheet by stamping and adapted to cover said lower part of said base panel of said bottom shell, said lower cover shell including a base panel adapted to cover said lower part of said base panel of said bottom shell, said base panel of said lower cover shell having a connecting side edge disposed at a top side thereof corresponding to said connecting part of said base panel of said bottom shell and adapted to abut against said connecting edge of said upper cover shell.

2. The housing as defined in claim 1, wherein said upper cover shell further includes a peripheral wall perpendicularly extending along the border of said base panel thereof corresponding to said peripheral wall of said bottom shell and defining an opening surrounded by said connecting side edge of said upper cover shell; said lower cover shell further includes a peripheral wall perpendicularly extending along the border of said base panel thereof corresponding to said peripheral wall of said bottom shell and defining an opening surrounded by said connecting side edge of said lower cover shell.

3. The housing as defined in claim 1, wherein said base panel of said upper cover shell includes a main body and a bottom extension extending downwardly from a bottom side of said main body of said upper cover shell and forming said connecting side edge of said upper cover shell; said base panel of said lower cover shell includes a main body and a top extension extending upwardly from a top side of said main body of said lower shell and forming said connecting side edge of said lower cover shell.

4. The housing as defined in claim 1, wherein said upper cover shell and said lower cover shell are respectively hinged to a position corresponding to said peripheral wall of said bottom shell at sides corresponding to said bottom shell and approaching said connecting part along a longitudinal axle thereof, whereby said upper cover shell and said lower cover shell can be respectively turned about the sides, said upper shell and said bottom shell being disposed with at least one lock therebetween, said lower shell and said bottom shell being disposed with at least one lock therebetween, said upper shell and said lower shell being respectively combined with said bottom shell by said lock.

5. The housing as defined in claim 1, wherein said upper part of said base panel of said bottom shell has two top corners respectively beveled and chamfered.

6. A housing comprising:
a bottom shell made of a metal sheet by stamping and including a base panel and a peripheral wall perpendicularly extending from a border of said base panel of said bottom shell, said base panel of said bottom shell including an upper part, a lower part, and a connecting part connected between said upper part and said lower part at a side thereof, and
a cover shell made of a metal sheet by stamping and adapted to close/open said bottom shell, said cover shell including a base panel fitting said base panel of said bottom shell, the border of said cover shell being abutted against said peripheral wall of said bottom shell when said cover shell is covered on said bottom shell.

7. The housing as defined in claim 6, wherein said cover shell further comprises a peripheral wall perpendicularly extending along the border of said base panel thereof and adapted to abut against said peripheral wall of said bottom shell.

8. The housing as defined in claim 6, said cover shell is hinged to a position corresponding to said peripheral wall of said bottom shell at a side corresponding to said bottom shell and approaching said connecting part along a longitudinal axle thereof, whereby said cover shell can be turned about the side, said cover shell and said bottom shell being disposed with at least one lock therebetween, said cover shell being combined with said bottom shell by said lock.

9. The housing as defined in claim 6, wherein said base panel of said bottom shell has two top corners respectively beveled and chamfered.
